(19) United States
(12) Patent Application Publication
(10) Pub. No.: US 2014/0148030 A1
(43) Pub. Date: May 29, 2014

(54) ELECTRICAL CONNECTION STRUCTURE BETWEEN MODULE DEVICE AND AN EXTERNAL DEVICE

(71) Applicant: SMK Corporation, Tokyo (JP)

(72) Inventor: Takanobu Makimura, Toyama-shi (JP)

(73) Assignee: SMK Corporation, Tokyo (JP)

(21) Appl. No.: 14/089,949

(22) Filed: Nov. 26, 2013

(30) Foreign Application Priority Data
Nov. 29, 2012 (JP) 2012 261610

(51) Int. Cl. H01R 13/52

(52) U.S. Cl. CPC H01R 13/521
USPC 439/271

(57) ABSTRACT

An electrical connection structure between a module device and an external device having high reliability of electrical connection and excellent assembling performance. The electrical connection structure a module device includes a module housing accommodating the module device having a mounting hole for mounting a cable connector electrically connected with an external device, a contact of the module device side disposed inside the module housing positioned in the mounting hole, the structure includes a terminal pressed and connected to the contact of the module device side, and a connector housing that accommodates and holds the terminal, the terminal is held in the connector housing so as to have airtight and watertight properties from a connection portion between the terminal and a core wire of a cable to a covering portion of the cable, and the cable connector and the housing are connected so as to have the watertight property.

### CROSS REFERENCE SECTION

This application claims priority under to Japanese patent application JP2012-261610 under 35 U.S.C. § 119(a) filed on Nov. 29, 2012, which is incorporated by reference herein in its entirety.

### BACKGROUND

1. Field of the Invention

The present invention generally relates to an electrical connector and more particularly, relates to a connection structure for electrically connecting a module device such as a camera with an external device such as a control device, power supply, and the like.

2. Description of Related Art

A module device such as a vehicle mounted camera is typically electrically connected to an external control device, power supply, etc. The electrical connection between the vehicle mounted camera and the external device is typically subjected to a variety of harsh environmental conditions, including but not limited to vibration as well as liquids (e.g., water). Despite efforts to date, designing an electrical connection that is both durable to withstand the environmental conditions and reliable to consistently provide a stable electrical connection is difficult. Thus, there remains a need in the art for a durable, reliable electrical connecter and further, there is a need for an easy to assemble electrical connector. An object of the present invention is to provide an electrical connection structure between a module device and an outside external device which has high reliability of electrical connection and excellent assembling performance.

### SUMMARY

An electrical connection structure between the module device and the outside device according to the invention includes a mounting hole for mounting a cable connector electrically connected to an external device, the mounting hole formed in a module housing that accommodates a module device, a contact of the module device side is disposed inside module the housing located in the mounting hole, the structure has a terminal pressed and connected to the contact of the module device side, and a connector housing that accommodates and holds the terminal, the terminal is held in the connector housing so as to have airtight and watertight properties from the connection portion between the terminal and a core wire of the cable to a covering portion of the cable, and the cable connector and the housing are connected to each other so as to have watertight property.

According to the invention, the assembling performance is improved by providing the mounting hole of the cable connector allowed to directly pass through the housing, and moisture is prevented from entering the housing by ventilation or the like via the cable interior.

Although there are various methods in such a waterproof means, for example, the terminal can be accommodated in the connector housing in a state in which the core wire of the cable is connected to the rear portion of the terminal, and portions from the connection portion between the terminal and the core wire of the cable to the covering portion of the cable can be embedded in a sealant.

In this context, the sealant refers to a material having the waterproof property. The connection portion between the terminal and the cable core to the covering portion of the cable are enclosed by this sealant. Various methods can be employed in this case.

For example, there are some methods such as a method of placing portions from the connection portion between the terminal and the core wire to the covering portion of the cable into a mold, and injecting and curing an adhesive into the mold, a method of injecting and molding a hot-melt resin, a method using an RIM molding (polymerization reaction and curing are performed in the mold) and the like.

Furthermore, in this case, the sealant is connected to the cable using a cord bushing, and the cord bushing and the housing may be fixedly connected with the fixing member via a seal member.

In the invention, since the connection structure is adopted that brings the terminal provided in the cable connector into pressure-contact with the contact of the module device side, the assembling performance is excellent.

In general, a plurality of connection terminals is required in the case of the module device.

In order to easily secure flatness, parallelism, and pressing force of the terminals in such a case, a retainer for supporting the terminals from the rear may be disposed in the state of accommodating the terminal in the connector housing.

In the external electrical connection structure of the module device according to the invention, since it is possible to directly electrically connect the cable connector to the mounting substrate of the module device side, while securing the waterproof property, the number of assembly steps is less than the prior art, and the connection structure becomes more compact.

### BRIEF DESCRIPTION OF DRAWINGS

FIG. 1 illustrates an example of an electrical connection structure between a module device and the outside according to the present invention;

FIG. 2A illustrates a state before a cable connector is connected to the module device, and FIG. 2B illustrates a connection state;

FIG. 3A illustrates a state before the connection of an example of another connection structure, and FIG. 3B illustrates a state after the connection thereof;

FIG. 4A illustrates a state in which a terminal is crimping-connected to each single line of a cable, and FIG. 4B illustrates a state in which the terminal is incorporated into a housing;

FIG. 5A illustrates a state in which a retainer is inserted from a side portion of the housing, and FIG. 5B illustrates a state in which the side portion of the terminal, the interior of the housing, and the end portion of the cable are embedded by a hot-melt molding product;

FIG. 6 illustrates a state in which a cord bushing is molded by insert molding;

FIG. 7A illustrates a cross-sectional view of the cable connector, and FIG. 7B illustrates a cross-sectional perspective view thereof; and

FIG. 8 illustrates an example of a conventional connection structure of the prior art.

### DETAILED DESCRIPTION

### Description of Reference Numerals

10 cable connector

11 connector housing

12 hot-melt molding body

13 cord bushing

14 cable

14a single line

14b core wire

15 terminal

16 retainer

17 seal member

18 fixing member

20 module device

21a rear case

21b front case

21c mounting hole

21d fixing hole

22 substrate

23 connector

24 contact

As discussed above, when a module device such as a monitor camera device (which is mounted to a vehicle) is electrically connected to an external control device, a power supply or the like, the module device requires reliability of electrical connection capable of withstanding the vibration or the like during driving of the vehicle, and further may requires high waterproof property.

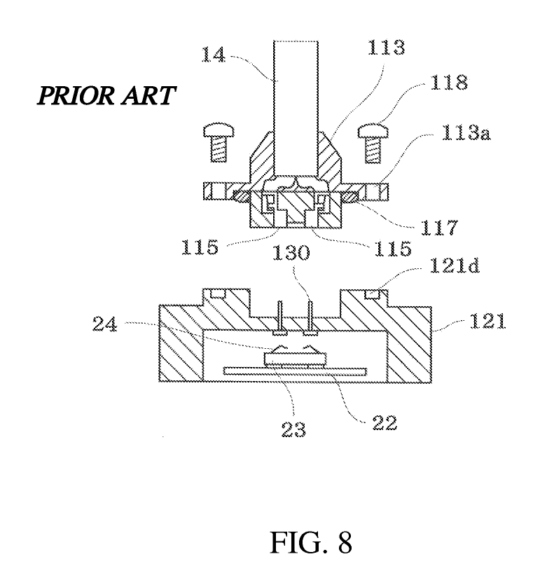

For example, one conventional electrical connector—disclosed in JP 2008-170801 A—highlights one attempt to provide an electrical device for a module device that secures reliability of the electrical connection and has high waterproof property. Such electrical an electrical connector is shown in FIG. 8. Particularly, FIG. 8 schematically illustrates an electrical connection structure between the module device and the external device.

Referring to FIG. 8, there is provided a connector terminal 130 passing through a wall of a housing 121 that is equipped with a module device such as a monitor camera device in a watertight state, and an inner end portion of the connector terminal 130 is pressed and connected to an elastic contact 24 of a connector 23 implemented on a substrate 22 of the module device side.

Meanwhile, a socket terminal 115 of a connector 113 attached to a leading end of a cable 14 is electrically connected to the outside of the connector terminal 130 allowed to pass through the housing 121.

The connector 113 is screwed into a female screw portion 121d by the use of a fixing member 118 via a fixing hole 113a so as to insert a seal member 117 into the housing 121.

Although the electrical connection structure as disclosed in JP 2008-170801 A is compact and has high waterproof property, such an electrical connection structure requires an significant assembling work of electrically connecting a substrate of the electrical module device and the inside of the connector terminal provided by passing through the housing, and an assembling work of electrically connecting the cable connector to the outside of the connector terminal Therefore, this requires an improvement in assembly performance and size reduction.

As discussed above, an object of the present invention is to provide an electrical connection structure between a module device and the outside which has high reliability of the electrical connection and excellent assembling performance.

Hereinafter, an example of an electrical connection structure according to the invention will be described with reference to the drawings.

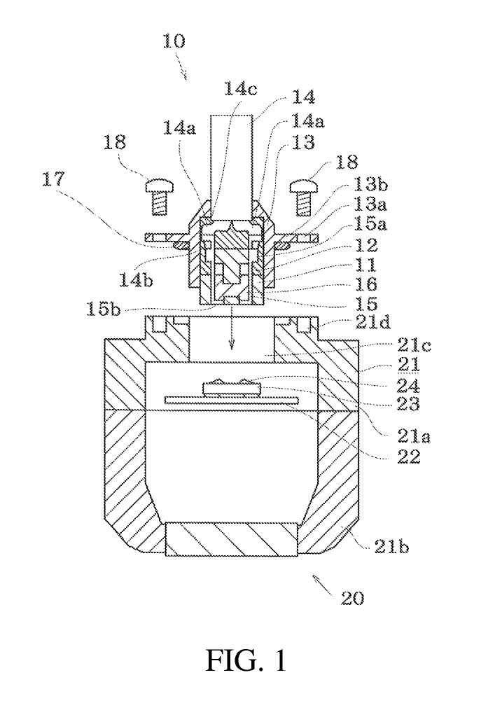

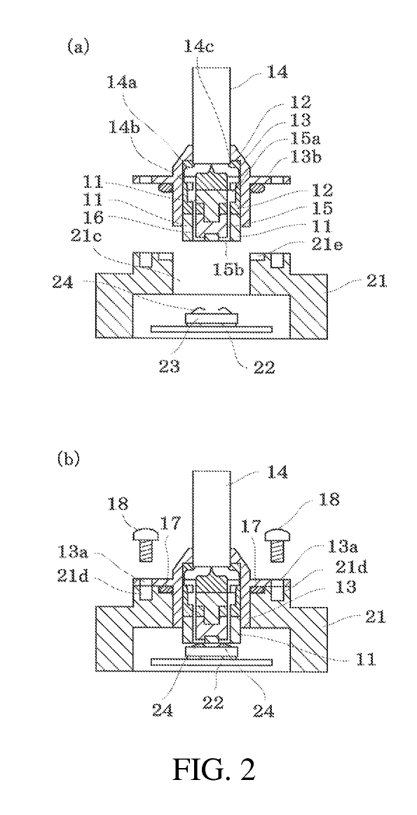

FIG. 1 illustrates a cross-sectional view, and FIG. 2 illustrates a connecting means. An embodiment illustrated in FIG. 1 is an example that connects a monitor camera device mounted on a vehicle to an external device via a cable.

This is an example in which a mounting hole 21c of a cable connector 10 is provided in a housing 21 equipped with a monitor camera as a module device 20.

FIG. 1 does not illustrate the monitor camera, and only represents a substrate 22, a connector 23 implemented on the substrate 22, and a contact 24 made of an elastic piece.

Since a mounting hole 21c is provided in the housing 21, in a state in which the monitor camera is built in the interior of a rear case 21a and a front case 21b constituting the housing 21, a portion between the rear case 21a and the front case 21b is first joined by welding or the like, and the monitor camera may be built in the housing.

The cable connector 10 has a connector housing 11, and a plurality of terminals 15 disposed inside the connector housing 11. The rear side of the terminal 15 is crimped to a core wire 14b of a single line 14a of a cable 14 by a crimping portion 15a, and portions from the crimping portion 15a to a covering end portion 14c of the cable 14 are embedded in a hot-melt molding body 12.

In addition, as long as the hot-melt molding body is a sealant having the waterproof property that is intended to prevent the ventilation (moisture penetration) via the interior of the cable 14, the hot-melt molding body is not limited to hot-melt resin.

A cord bushing 13 is molded by the insert molding so as to include a portion from an outer peripheral portion of the connector housing 11 to an outer peripheral portion of the hot-melt molding body 12.

Furthermore, when the terminal 15 is disposed inside the connector housing 11, a retainer 16 for supporting, from the back side, a terminal contact surface 15b formed by bending the leading end side of the terminal 15 substantially at a right angle.

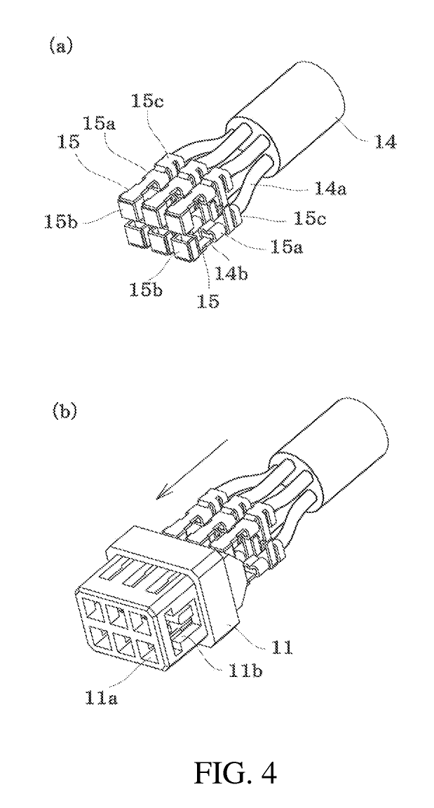

FIGS. 1 and 2 schematically represent these structures in cross-sectional views. For example, FIG. 2A illustrates a state before a cable connector is connected to the module device, and FIG. 2B illustrates a connection state. Specific examples of the assembly procedure of the cable connector are further illustrated in FIGS. 4 to 7.

FIG. 4 illustrates an example of a 6P type in which six crimp terminals are crimped and connected to each single line 14a of the cable 14.

In addition, the invention is not limited to the 6P type. The terminal 15 has a caulking portion 15c caulked with the covering portion of the single line 14a of the cable, and a crimping portion 15a caulking-crimped to the core wire 14b of the single line on the rear side.

The leading end of the terminal 15 is formed with a terminal contact surface 15b coming into pressure-contact with the contact 24 made of an elastic piece of the module device side by being bent at a right angle.

In such a state, each terminal 15 is incorporated into the inside of the housing 11 from the back side of the housing 11, as illustrated in FIG. 4B.

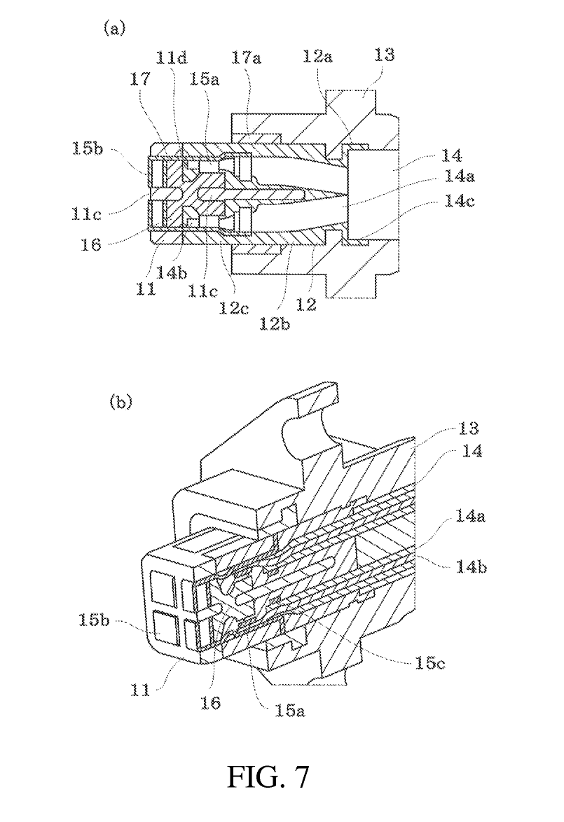

An example of the internal structure of the housing 11 is illustrated in FIG. 7.

The housing 11 has a terminal hole 11a through which the terminal contact surface 15b of each terminal 15 of 6P is inserted, and has a retainer insertion hole 11b for inserting the retainer 16 that supports the terminal contact surface 15b from the back side.

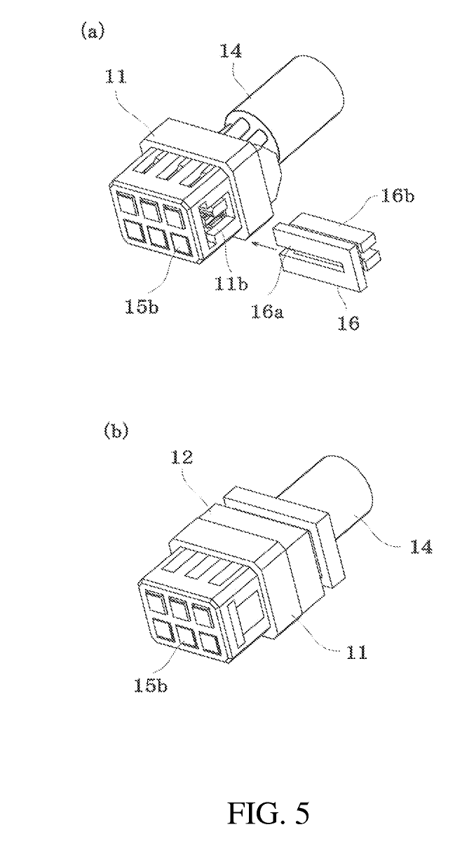

As illustrated in FIG. 5, the retainer 16 has a support surface 16a of the terminal 15, and an engagement portion 16b engaging the retainer with the housing 11, and is inserted from the side portion of the housing 11.

The interior of the housing 11 has ribs 11c and 11d as illustrated in FIG. 7, and the engagement portion 16b of the retainer 16 is engaged with the ribs.

Next, as illustrated in FIG. 5B, the interior of the housing 11, the crimping portion 15a of the terminal 15, and a portion from the cable single line 14a to the covering end portion 14c of the cable 14 are embedded into the hot-melt molding body 12 molded by injecting the hot-melt resin (12a to 12c).

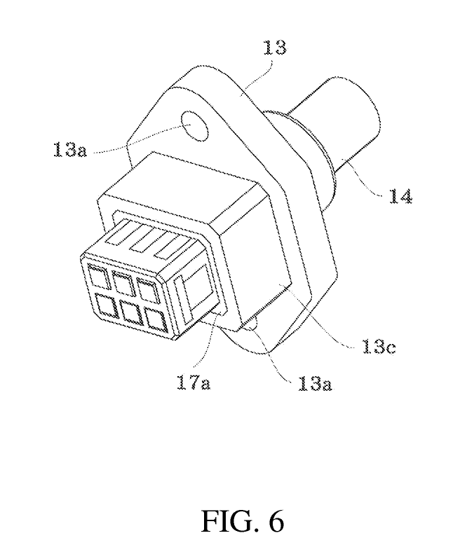

Next, the cord bushing 13 is molded by the insert molding so as to enclose the hot-melt molding body 12 from the rear portion of the connector housing 11 as illustrated in FIG. 6.

In addition, an example illustrated in FIG. 6 illustrates an example of providing a seal member 17a between the cord bushing and the housing 11.

The cord bushing 13 has a loading portion 13c charged to the mounting hole 21c of the housing 21, and a flange portion 13b, and the flange portion 13b has a mounting hole 13a.

A cross-sectional structure thereof is illustrated in FIG. 7.

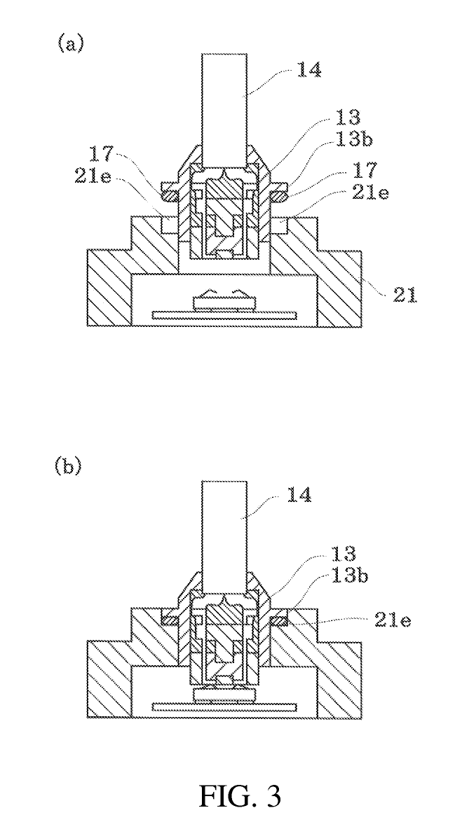

As a method for connecting and fixing the cable connector 10 and the housing 21, as illustrated in FIGS. 1 and 2, a fixing member 18 such as a screw may be screwed into a female screw portion (fixing hole) 21d of the housing 21 so as to interpose the seal member 17 between the flange portion 13b and the housing 21 via the mounting hole 13a provided in the flange portion 13b. Furthermore, as illustrated in FIG. 3, a method may be provided which fits the flange portion 13b to a fitting hole 21e so as to interpose the seal member 17 by providing the fitting hole in the housing 21.

What is claimed is:

1. An electrical connection structure between a module device and an external device comprising:
a module housing accommodating the module device having a mounting hole for mounting a cable connector electrically connected with the external device; and
a contact of the module device disposed inside the module housing positioned in the mounting hole,
wherein, the electrical connection structure includes a terminal configured to connect to the contact of the module device, and a connector housing that accommodates and holds the terminal, and
wherein, the terminal is held in the connector housing so as to have airtight and watertight properties from a connection portion between the terminal and a core wire of a cable to a covering portion of the cable, wherein the connection portion and the housing are connected so as to have the watertight property.

2. The electrical connection structure between a module device and an external device according to claim 1,
wherein, the terminal is accommodated in the connector housing in a state in which the core wire of the cable is connected to the rear portion of the terminal, and
wherein, portions from the connection portion between the terminal and the core wire of the cable to the covering portion of the cable are embedded in a sealant.

3. The electrical connection structure between a module device and an external device according to claim 2,
wherein, the sealant is connected to the cable using a cord bushing, and
wherein, the cord bushing and the housing are fixedly connected with a fixing member via a seal member.

4. The electrical connection structure between a module device and an external device according to claim 3,
wherein, a retainer for supporting the terminal from the rear is disposed in the connector housing and in a state of accommodating the terminal.
